(19) United States
(12) Patent Application Publication
(10) Pub. No.: US 2026/0216735 A1
(43) Pub. Date: Jul. 30, 2026

(54) SYSTEM AND METHOD FOR SEGREGATION OF MATERIALS FROM SHREDDED LITHIUM-ION BATTERIES

(71) Applicant: METASTABLE MATERIALS PRIVATE LIMITED, Baghpat, Uttar Pradesh (IN)

(72) Inventors: Shubham VISHVAKARMA, Baraut (IN); Manikumar UPPALA, Nalgonda (IN)

(73) Assignee: METASTABLE MATERIALS PRIVATE LIMITED, Baghpat, Uttar Pradesh (IN)

(21) Appl. No.: 18/744,030

(22) PCT Filed: Apr. 20, 2023
(86) PCT No.: PCT/IN2023/050385

§ 371 Date: Jun. 14, 2024

(30) Foreign Application Priority Data
Apr. 20, 2022 (IN) 202211023412

(51) Int. Cl. B03B 9/06; B03B 5/02; B07B 1/06; H01M 10/54

(52) U.S. Cl. CPC B03B 9/061; B03B 5/02; B07B 1/06; H01M 10/54; B03B 2009/066; B07B 2230/01

(57) ABSTRACT

The various embodiments of the present invention provide a system and method for segregation of materials from shredded Lithium-ion batteries. The embodiments also provide an integrated mechanism to segregate metal, polymer and black-mass from shredded Lithium-ion batteries. The present invention provides a system for classification and segregation of shredded material from Lithium-ion batteries through agitation and density separation processes. The system is designed to perform three tasks in a sequential manner: firstly, to open up the layers of batteries i.e., to separate the layers of the different material; secondly, to separate the polymers and black-mass from the layers; and, thirdly to separate the foils of the batteries into low/high density material, suspension and by brittleness of material. The invention provides a system for an optimized separation and segregation of a plurality of materials from shredded Lithium-ion batteries.

### REFERENCE TO RELATED APPLICATION

The embodiments herein claim the priority of the Indian Provisional Patent Application filed on Apr. 20, 2022, with the number 202211023412 and PCT Applic. No. PCT/IN2023/050385, filed Apr. 20, 2023, the contents of which are included in entirety as reference herein.

### FIELD OF THE INVENTION

The present invention is generally related to Lithium-ion batteries. The present invention is more particularly related to a system and method for segregation of materials from shredded Lithium-ion batteries.

### BACKGROUND OF THE INVENTION

The shredding of used Lithium-ion batteries is a process that needs specialized conditions for safe disposal of the shredded batteries due to the danger of explosion, fire and other hazard during the shredding process. The process includes the segregation of a plurality of different materials obtained from the shredded Lithium-ion batteries.

Current methods of segregation of materials from shredded Lithium-ion batteries are not performed for most pyrometallurgical processes. For hydrometallurgy-based processes, currently a complex set of processes using several stages of crushing and density separation are employed for segregation of materials. Typically, a hammer mill and crushers are used to open-up layers and several stages of classification are performed for segregation of materials. However, the end products of these processes still contain cross contamination of the plurality of material onto one another, and hence, a proper segregation of the extracted materials is not achieved in hydrometallurgical process.

Hence, there exists a need for an integrated mechanism to segregate metal, polymer and black-mass from shredded Lithium-ion batteries. There also exists a need for a system for classification and segregation of shredded material from Lithium-ion batteries through agitation and density separation processes.

The abovementioned shortcomings, disadvantages and problems are addressed herein, which will be understood by reading and studying the following specification.

### OBJECT OF THE INVENTION

The primary object of the present invention is to provide a system and method for segregation of materials from shredded Lithium-ion batteries.

Another object of the present invention is to provide an integrated mechanism to segregate metal, polymer and black-mass by using properties such as high/low density, suspension or brittleness from shredded Lithium-ion batteries.

Yet another object of the present invention is to provide a system for classification and segregation of shredded material from Lithium-ion batteries through agitation and density separation processes.

Yet another object of the present invention is to provide a system for an optimized separation and segregation of a plurality of materials from shredded Lithium-ion batteries.

These and other objects and advantages of the present invention will become readily apparent from the following detailed description taken in conjunction with the accompanying drawings.

### SUMMARY OF THE INVENTION

The various embodiments of the present invention provide a system and method for segregation of materials from shredded Lithium-ion batteries. The embodiments also provide an integrated mechanism to segregate metal, polymer and black-mass from shredded Lithium-ion batteries.

According to one embodiment of the present invention, a system is provided for segregation of materials from shredded Lithium-ion batteries. The system comprises a large tank for the agitation process, which is attached to a material inlet mechanism and a material outlet mechanism. The large tank is supported on a frame. The system is designed to perform three tasks in a sequential manner: firstly, to open up the layers of batteries, i.e., to separate the layers of the different material; secondly, to separate the polymers and black-mass from the layers; and, thirdly to separate the foils of the batteries into low/high-density material, and separate the brittle/ductile material by their sizes. The tank is made up of a frame and a skin, comprising multiple layers, where the skin and inner layers of the tank are made of material that are immune to materials from shredded batteries, such as fluoropolymers, fluro-elastomer and some alloys of nickel or materials coated with one or more of these materials.

According to one embodiment of the present invention, the shredded Lithium-ion batteries are put in the system through the material inlet mechanism and then the agitation mechanism is activated. The agitation blades are joined with a shaft, and the shaft is joined with the rest of the mechanism using reverse thread, which makes the shaft easily interchangeable. This assembly is supported on the cover using the shaft housing and attached with motor using a belt and pully system. This whole system is supported on the main frame so that any torque and vibration are not transferred to the tank and corresponding tank skin. The cover along with the blade and rotation mechanism contains vision slit, material inlet, water inlet spray along with various ports for sensors and accessories required for monitoring and process-control. The material is then agitated several times at varied solid/liquid ratios for a predetermined time and speed of the shaft, and with different shaft blades.

According to one embodiment of the present invention, the material outlet mechanism comprises a sealed door with a sieve and a cover provided at the bottom of the tank. The sieve size is between 250 microns to 5 mm, and the suspension is removed using the sieve. The sieve selection controls the particle size in suspension and black-mass subsequently. After sieving, water is poured back using an inlet spray, and this removes the black-mass by washing settled black-mass away from low-density material and high-density material. When a preset level of material black-mass is removed and the water becomes clear, the low density material floats over at the top of the water level and it is drained away using overflow. The sieve doors are then opened to remove the high-density material.

According to yet another embodiment, the inner skin of multi-layer tank is perforated, and the sieve is replaced with a pump apparatus which is attached to the outer layer of the tank apparatus. The agitated material is constantly pumped out of the tank and sent for further processing. The material with larger diameter remains in the tank on the perforated layers of the tank, which are removed in batches, and wherein, the processing parameters and speed of the pumping are controlled for removal of a plurality of material in different stages.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIGS. 1a and 1b illustrate the sectional view and isometric view, respectively, of a system for the segregation of materials from shredded Lithium-ion batteries, according to one embodiment of the present invention.

FIGS. 2a and 2b illustrate the sectional view and isometric view, respectively, of an exemplary implementation of a system for segregation of materials from shredded Lithium-ion batteries, according to one embodiment of the present invention.

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a system and method for segregation of materials from shredded Lithium-ion batteries. The embodiments also provide an integrated mechanism to segregate metal, polymer and black-mass from shredded Lithium-ion batteries.

According to one embodiment of the present invention, a system for segregation of materials from shredded Lithium-ion batteries is provided. The system comprises a material inlet mechanism, an agitation apparatus, a supporting frame, a material segregation module and a material outlet mechanism. The material inlet mechanism is designed to enable the shredded Lithium-ion batteries to be fed into the system for segregation. The agitation apparatus further comprises a tank arrangement, a motor, a pulley-belt arrangement, an agitator frame, agitation blades, a shaft, a shaft supporting unit, a water inlet and spray unit, a gas inlet port, a viewing port and tank lids. The supporting frame is designed to support the agitation apparatus. The material segregation module is a sieve or a pump apparatus. The material outlet mechanism is designed to remove the segregated materials from the system for further processing.

According to one embodiment of the present invention, the tank arrangement in the agitation apparatus comprises a plurality of layers of tubing and an outer skin layer. The plurality of layers and the outer skin are made up of materials that are chemically inert to the constituents of chemicals from shredded batteries. The plurality of layers of the tank arrangement are comprised of a plurality of materials, including stainless steel, Polypropylene, fluoropolymers, Fluro elastomer, some alloys of Nickel. The innermost layer is a solid layer comprised on the walls of the tank arrangement, and the intermediate layers between an outer cover layer and the innermost layer comprise perforated sheets.

According to one embodiment of the present invention, the agitation apparatus is designed to agitate the material a plurality of times with different solid-to-liquid ratios for preset time, RPM of the shaft, and a plurality of shaft configurations. The agitation blades are mechanically coupled to the shaft and the shaft is further connected to the rest of the system through a reverse thread, thereby making it interchangeable. The shaft and agitation blades assembly are supported on the cover using the shaft housing and attached with the motor using a pully-belt arrangement. The whole system is supported on the mainframe so that any torque and vibration are not transferred to the tank and corresponding skin. The cover along with the blade and rotation mechanism comprise a vision slit, material inlet and water inlet and spray unit along with a plurality of ports for sensors and accessories required for monitoring and process control.

According to one embodiment of the present invention, the material segregation module is designed to separate the plurality of materials formed as a result of agitation of shredded Lithium-ion batteries. The plurality of materials includes a plurality of polymers, metallic foils and black-mass. The plurality of polymers is obtained in the form of a suspension.

According to one embodiment of the present invention, the material segregation module comprises at least one of a sieve or a pump apparatus. The sieve is provided at the bottom of the tank arrangement, and the sieve further includes a sealed door and a cover. A sieve selection controls is provided to configure the size of the particle to be separated through sieving in the suspension and the black-mass. The water inlet and spray unit is designed to spray water in the suspension and the black-mass for washing the material. The sealed door is designed to open for the removal of high-density material that settles in the bottom. The low-density material that floats on the top of the water that is sprayed is removed through over-flowing. According to one embodiment, the sieve is replaced with a pump apparatus which is attached to the outer layer of the tank apparatus and the agitated material is constantly pumped out of the tank and sent for further processing. The material with larger diameter remains in the tank on the perforated layers of the tank, which are removed in batches. The processing parameters and speed of the pumping are controlled for removal of a plurality of material in different stages.

According to one embodiment of the present invention, a method is provided for segregation of materials from shredded Lithium-ion batteries. The method includes: activating a material inlet mechanism to introduce shredded Lithium-ion batteries into an agitation apparatus; separating a plurality of layers and materials in shredded Lithium-ion batteries through mechanical agitation in a tank arrangement in the agitation apparatus; subjecting the agitated material mixture through a material segregation module for density-separation of a plurality of polymers, foils and black-mass obtained after agitation, wherein, the material mixture is broken down based on the proportion of their ductility; and, removing the segregated material separately through a material outlet mechanism for further processing.

According to one embodiment of the present invention, a system is provided for segregation of materials from shredded Lithium-ion batteries. The system comprises a large tank for the agitation process, which is attached to a material inlet mechanism and a material outlet mechanism. The large tank is supported on a frame. The system is designed to perform three tasks in a sequential manner: firstly, to open up the layers of batteries, i.e., to separate the layers of the different material; secondly, to separate the polymers and black-mass from the layers; and, thirdly to separate the foils of the batteries into low/high-density, suspension or brittleness of material. The tank is made of frame for example steel tubes with several layers of skin, where the skin and inner layers of the tank are made of materials that are immune to materials from shredded batteries, such as fluoropolymers, fluro-elastomer and some alloys of nickel or materials coated with one or more of these materials.

According to one embodiment of the present invention, the shredded Lithium-ion batteries are put in the system through the material inlet mechanism and then the agitation mechanism is activated. The agitation blades are joined with a shaft, and the shaft is joined with the rest of the mechanism using reverse thread, which makes the shaft easily changeable. This assembly is supported on the cover using the shaft housing and attached with motor using a belt and pully system. This whole system is supported on the main frame so that any torque and vibration are not transferred to the tank and corresponding skin. The cover along with the blade and rotation mechanism contains vision slit, material inlet, water inlet spray along with various ports for sensors and accessories required for monitoring and process control. The material is then agitated several times at varied solid/liquid ratios for a predetermined time and speed of the shaft, and with different shaft blades.

According to one embodiment of the present invention, the material outlet mechanism comprises a sealed door with a sieve and a cover provided at the bottom of the tank. The sieve size is between 250 microns to 5 mm, and the suspension is removed using the sieve. The sieve selection controls the particle size in suspension and black-mass subsequently. After sieving, water is poured back using an inlet spray, and this removes the black-mass by washing settled black-mass away from low-density material and high-density material. When a preset level of material black-mass is removed and the water becomes clear, the low density material is floated over at the top of the water level and it is drained away using overflow. The sieve doors are then opened to remove the high-density material.

According to yet another embodiment, the inner skin of multi-layer tank is perforated, and the sieve is replaced with a pump apparatus which is attached to the outer layer of the tank apparatus. The agitated material is constantly pumped out of the tank and sent for further processing. The material with larger diameter remains in the tank on the perforated layers of the tank, which are removed in batches, and wherein, the processing parameters and speed of the pumping are controlled for removal of a plurality of material in different stages.

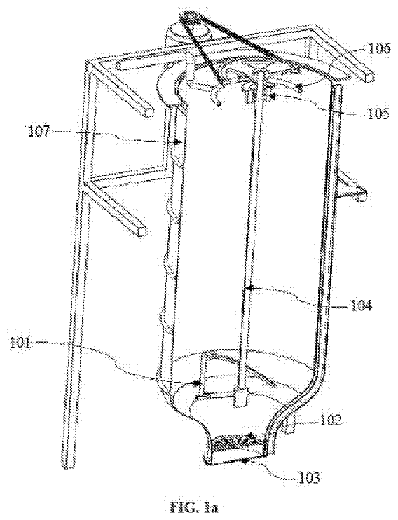

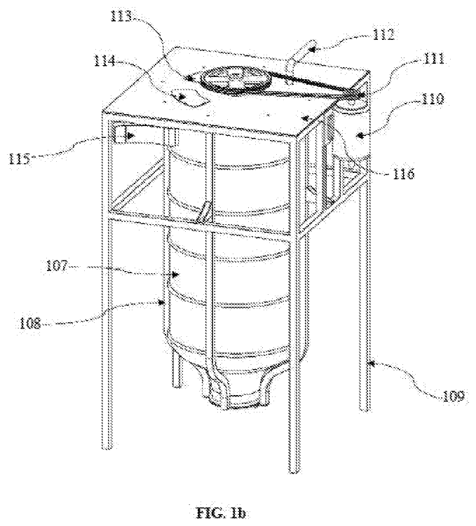

FIGS. 1a and 1b illustrate the sectional view and isometric view, respectively, of a system for the segregation of materials from shredded Lithium-ion batteries. The system comprises a Blade 101, a Sieve 102, a Lower Cap 103, a Shaft 104, a Shaft supporting Unit 105, a Water Inlet 106, a Spray unit 107, a Tank Skin 108, a Tank Frame 109, an External Frame 110, a Motor 111, a Pulley and Belt unit 112, a Water Inlet port 113, a Material Inlet Port 114, a Viewing port 115, a Light Particles separation port 116 and a Tank Lid 117.

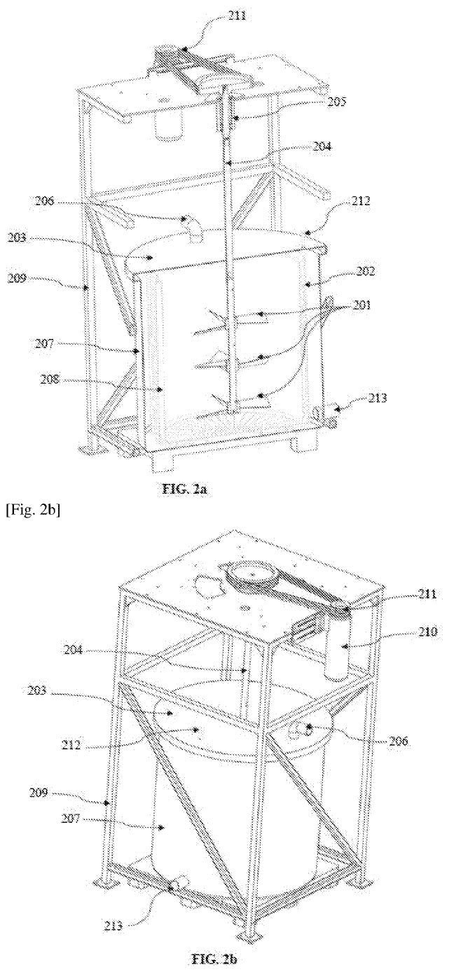

FIGS. 2a and 2b illustrate the sectional view and isometric view, respectively, of an exemplary implementation of a system for segregation of materials from shredded Lithium-ion batteries. The implementation comprises Blades 201, a Perforated Tank 202, a Tank Lid 203, a Shaft 204, a Housing 205, a Water Inlet port 206, an Outer Tank 207, an Inner Tank 208, an Agitator Frame 209, a Motor 210, a Pulley-and-Belt unit 211, a Gas Inlet port 212 and a Material Outlet Port 213.

Although the embodiments herein are described with various specific embodiments, it will be obvious for a person skilled in the art to practice the embodiments herein with modifications.

### ADVANTAGEOUS EFFECTS OF THE INVENTION

The various embodiments of the present invention provide a system and method for segregation of materials from shredded Lithium-ion batteries. The embodiments also provide an integrated mechanism to segregate metal, polymer and black-mass from shredded Lithium-ion batteries. The present invention provides a system for classification and segregation of shredded material from Lithium-ion batteries through agitation and density separation processes. The invention provides a system for an optimized separation and segregation of a plurality of materials from shredded Lithium-ion batteries. The invention reduces any complexities that are present with conventional processes for segregation of materials and reduce the requirement for resources employed for a successful functioning of the system.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A system for segregation of materials from shredded Lithium-ion batteries, the system comprising:
a material inlet mechanism, wherein the material inlet mechanism is designed to enable the shredded Lithium-ion batteries to be fed into the system for segregation;
an agitation apparatus, wherein the agitation apparatus further comprises a tank arrangement, a motor, a pulley-belt arrangement, an agitator frame, agitation blades, a shaft, a shaft supporting unit, a water inlet and spray unit, a gas inlet port, a viewing port and tank lids;
a supporting frame, wherein, the supporting frame is designed to support the agitation apparatus; and,
a material segregation module, wherein, the material segregation module is a sieve or a pump apparatus; and,
a material outlet mechanism, wherein the material outlet mechanism is designed to remove the segregated materials from the system for further processing.

2. The system as claimed in claim 1, wherein the tank arrangement in the agitation apparatus comprises a plurality of layers of tubing and a outer skin layer, and wherein, the plurality of layers and the outer skin are made up of materials that are chemically inert to the constituents of chemicals from shredded batteries, and wherein, the plurality of layers of the tank arrangement are comprised of a plurality of materials, including stainless steel, Polypropylene, fluoropolymers, Fluro elastomer, some alloys of Nickel, and wherein, the innermost layer is a solid layer comprised on the walls of the tank arrangement, and wherein, the intermediate layers between an outer cover layer and the innermost layer comprise perforated sheets.

3. The system as claimed in claim 1, wherein the agitation apparatus is designed to agitate the material a plurality of times with different solid-to-liquid ratios for preset time, RPM of the shaft, and a plurality of shaft configurations, and wherein the agitation blades are mechanically couple to the shaft and the shaft is further connected to the rest of the system through a reverse thread, thereby making is interchangeable, and wherein, the shaft and agitation blades assembly is supported on the cover using the shaft housing and attached with the motor using a pully-belt arrangement, and wherein, the whole system is supported on the mainframe so that any torque and vibration are not transferred to the tank and corresponding skin, and wherein, the cover along with the blade and rotation mechanism comprise a vision slit, material inlet and water inlet and spray unit along with a plurality of ports for sensors and accessories required for monitoring and process control.

4. The system as claimed in claim 1, wherein the material segregation module is designed to separate the plurality of materials formed as a result of agitation of shredded Lithium-ion batteries, and wherein, the plurality of materials includes a plurality of polymers, metallic foils and black-mass, wherein, the plurality of polymers is obtained in the form of a suspension.

5. The system as claimed in claim 1, wherein the material segregation module comprises at least one of a sieve or a pump apparatus, and wherein, the sieve is provided at the bottom of the tank arrangement, and the sieve further includes a sealed door and a cover, and wherein, a sieve selection controls is provided to configure the size of the particle to be separated through sieving in the suspension and the black-mass, and wherein, the water inlet and spray unit is designed to spray water in the suspension and the black-mass for washing the material, and wherein, the sealed door is designed to open for the removal of high density material that settles in the bottom, and wherein, the low-density material that floats on the top of the water that is sprayed is removed through over-flowing, and wherein, according to one embodiment, the sieve is replaced with a pump apparatus which is attached to the outer layer of the tank apparatus and the agitated material is constantly pumped out of the tank and sent for further processing, and wherein, the material with larger diameter remains in the tank on the perforated layers of the tank, which are removed in batches, and wherein, the processing parameters and speed of the pumping are controlled for removal of a plurality of material in different stages.

6. A method for segregation of materials from shredded Lithium-ion batteries, the method comprising:
activating a material inlet mechanism to introduce shredded Lithium-ion batteries into an agitation apparatus;
separating a plurality of layers and materials in shredded Lithium-ion batteries through mechanical agitation in a tank arrangement in the agitation apparatus;
subjecting the agitated material mixture through a material segregation module for density-separation of a plurality of polymers, foils and black-mass obtained after agitation, wherein, the material mixture is broken down based on the proportion of their ductility; and,
removing the segregated material separately through a material outlet mechanism for further processing.

7. The method as claimed in claim 6, wherein the tank arrangement in the agitation apparatus comprises a plurality of layers of tubing and a outer skin layer, and wherein, the plurality of layers and the outer skin are made up of materials that are chemically inert to the constituents of chemicals from shredded batteries, and wherein, the plurality of layers of the tank arrangement are comprised of a plurality of materials, including stainless steel, Polypropylene, fluoropolymers, Fluro elastomer, some alloys of Nickel, and wherein, the innermost layer is a solid layer comprised on the walls of the tank arrangement, and wherein, the intermediate layers between an outer cover layer and the innermost layer comprise perforated sheets.

8. The method as claimed in claim 6, wherein the agitation apparatus is designed to agitate the material a plurality of times with different solid-to-liquid ratios for preset time, RPM of the shaft, and a plurality of shaft configurations, and wherein the agitation blades are mechanically couple to the shaft and the shaft is further connected to the rest of the system through a reverse thread, thereby making is interchangeable, and wherein, the shaft and agitation blades assembly is supported on the cover using the shaft housing and attached with the motor using a pully-belt arrangement, and wherein, the whole system is supported on the mainframe so that any torque and vibration are not transferred to the tank and corresponding skin, and wherein, the cover along with the blade and rotation mechanism comprise a vision slit, material inlet and water inlet and spray unit along with a plurality of ports for sensors and accessories required for monitoring and process control.

9. The method as claimed in claim 6, wherein the material segregation module is designed to separate the plurality of materials formed as a result of agitation of shredded Lithium-ion batteries, and wherein, the plurality of materials includes a plurality of polymers, metallic foils and black-mass, wherein, the plurality of polymers is obtained in the form of a suspension.

10. The method as claimed in claim 6, wherein the material segregation module comprises at least one of a sieve or a pump apparatus, and wherein, the sieve is provided at the bottom of the tank arrangement, and the sieve further includes a sealed door and a cover, and wherein, a sieve selection controls is provided to configure the size of the particle to be separated through sieving in the suspension and the black-mass, and wherein, the water inlet and spray unit is designed to spray water in the suspension and the black-mass for washing the material, and wherein, the sealed door is designed to open for the removal of high density material that settles in the bottom, and wherein, the low-density material that floats on the top of the water that is sprayed is removed through over-flowing, and wherein, according to one embodiment, the sieve is replaced with a pump apparatus which is attached to the outer layer of the tank apparatus and the agitated material is constantly pumped out of the tank and sent for further processing, and wherein, the material with larger diameter remains in the tank on the perforated layers of the tank, which are removed in batches, and wherein, the processing parameters and speed of the pumping are controlled for removal of a plurality of material in different stages.
